(19) United States
(12) Patent Application Publication
(10) Pub. No.: US 2003/0061087 A1
(43) Pub. Date: Mar. 27, 2003

(54) Calendar scheduling of multiple persons resources and consumables with group access view restriction

(76) Inventor: Paul Srimuang, San Diego, CA (US)

Correspondence Address: David B Woycechowsky, Luce Forward Hamilton & Scripps, Suite 2600, 600 West Broadway, San Diego, CA, 92101, US

(21) Appl. No.: 10/181,361

(22) PCT Filed: Jan. 12, 2001
(86) PCT No.: PCT/US01/01055

(51) Int. Cl. G06F 17/60

(52) U.S. Cl. 705/8

(57) ABSTRACT

Calendaring and scheduling software (100) wherein separate groups are separately administered, especially with respect to access rules (124) and the related ability to self-reserve appointments. Also, scheduling rules, schedule conflict rules and resource scheduling for use in vendor (108)/customer (110, 112) scheduling and customer self-reservation of vendor appointments.

### PRIORITY INFORMATION

The present application claims all applicable priority and other legal benefit based on the following application(s): (1) U.S. provisional application No. 60/176,205 filed on Jan. 14, 2000; and (2) U.S. provisional application No. 60/176,204 filed on Jan. 14, 2000.

### FIELD OF THE INVENTION

The present invention is directed to scheduling and calendaring software, and more particularly to calendaring and scheduling software for use by businesses that provide services and/or products to customers.

### BACKGROUND OF THE INVENTION

Conventional scheduling and calendaring software allows individuals to schedule appointments by computer, and to organize these appointments into various calendar format(s) for future reference. There are a lot of advantages to implementing scheduling and calendar by computer, especially when the computer is connected to a wide-ranging computer network, such as the Internet.

For example, appointments can be added, revised and deleted using the computer. Appointments can be efficiently requested of several parties simultaneously by email. Also, if a third party requests an appointment by email, it can be a simple matter to add this appointment to the calendar. As a matter of fact, some computer-based calendars will automatically add an appointment based on an appropriately formatted email appointment request, upon a confirmation from the recipient that the appointment is accepted. Also, communicating acceptance (by email) of an accepted appointment back to the appointment requestor is also simple to accomplish, and some computer-based calendars have expedients for acceptance emails.

Other computer-based calendar features include: (1) meeting notification; (2) various accommodations for parties in different time zones (see, U.S. Pat. No. 6,016,478 to Zhang, et al. and U.S. Pat. No. 5,960,406 to Rasansky, et al.—both of which are herein incorporated by reference); and (3) Internet groupware that shares group members' individual schedules (see U.S. Pat. No. 6,018,343 to Wang, et al.—herein incorporated by reference).

One important issue in the world of computer-based calendars is the issue of who has access to view an individual's calendar (that is, “view access”), and who has access to make changes to an individual's calendar (that is, “revision access”) More particularly, in most computer-based calendars, third parties do not have view access or revision access. This is good in that it protects the privacy of the individual to whom the calendar belongs. On the other hand, this is bad in that third parties have to wait for the intervention of the calendar's “owner” to get an idea of available appointment times, or to accept or reject proposed appointments.

However, sometimes it is acceptable for at least some third parties to have view access and/or revision access. For example, an employer may want view access and/or revision access for the computer-based calendars that it supplies to its employees. Accordingly, there are computer-based calendars that permit some level of view access and/or revision access for third parties (such as the calendar “owner's” employer). Generally, these calendars work best in an intranet setting, where there is some control over the identity of participants in the computer-based calendar software. In this way, there is some assurance that the view access and/or revision access will be administered and exercised only in a responsible manner.

### SUMMARY OF THE INVENTION

The present invention recognizes some shortcomings in the above-described computer-based calendaring and scheduling software. More particularly, individuals often need to keep two or more calendars. For example, an individual may keep a work calendar for work-related activities, and a social calendar for social activities. The work calendar is subject to view access and revision access according to the administration settings selected by the employer. The community calendar is subject to view access and/or revision access as dictated by the administration settings chosen by the administrator of the particular community calendar. The present invention recognizes that the existence of such multiple computer-based calendars is something of a problem, because multiple calendars must be consulted and maintained separately, which involves extra time and effort on an ongoing basis.

The present invention deals with this perceived problem by grouping parties into groups for the purposes of view access and/or revision access to a computer-based calendar. Each group has a set of view access and/or revision access rules to determine how third parties of the group can access the calendar. This way, a group that is allowed a high level of access (e.g., co-workers) can be differentiated from a group that has a lower level of access (e.g., a community group). This concept of grouping third parties has especially advantageous application in the context of calendars used by business to schedule business related appointments (e.g., hair salon appointments, doctor's office appointments, oil change service appointments), because these businesses will benefit by allowing customers to have a controlled level of effective access to the calendars of the employees (and other resources) of the business. The calendar groups of the present invention can facilitate more granulated control of access to various calendar data and functions.

According to a further aspect of the present invention, certain new kinds of calendaring can be performed. For example, a non-consumable resource (such as a barber chair, a meeting room or an oil change station) can be scheduled and maintain a calendar similar to calendar's of people. Appointments can be scheduled with combinations of people and non-consumable resources using the computer-based calendar of the present invention, so that it can be quickly and reliably assured that both the people and the resources necessary for an appointment will be available. Consumable resources may also be scheduled along with people and/or resources, so that adequate consumable resources (e.g. shampoo, motor oil, tongue depressors) can be maintained at sufficient levels to handle all scheduled meetings.

For example, businesses may determine whether their customers only can select a desired service (e.g., an oil change), or whether they have the additional ability to select specific human, consumable and non-consumable resources. Under the alternative wherein no resource choice is given to customers, the scheduling software can still determine availability of the service by checking on the availability of the combination of human and/or other resources necessary to perform the service.

According to a further aspect of the present invention, people or resources can be scheduled according to new, inventive types of scheduling rules. For example, a person (e.g., a medical doctor) may be allowed to schedule multiple appointments in a single half hour period of time. Also, people or resources that can schedule more than one appointment in a time period may be allowed to schedule appointments only up to some predetermined maximum number of appointments for a time period. For example, an oil change bay may be allowed to have scheduled a maximum of 12 appointments over a four hour time period. Such a rule reflects the fact that it is not always practical to schedule each specific appointment exactly, but that there still should be some control over how many separate appointments are allowed in a predetermined period of time.

As another variation in scheduling service appointments, while the customer may schedule a single service appointment to occur during some desired time interval, the scheduling program may specifically schedule the various people and resources for only the portions of the service time interval where they will be needed. For example, if an appointment for a medical exam is to last one hour, the appointment may require: (1) a nurse for the first 10 minutes of the hour and the last 20 minutes of the hour; (2) an examination room for the first 20 minutes and last 20 minutes of the hour; (3) an x-ray room for the middle 20 minutes of the hour; and (4) a doctor for the final 30 minutes of the hour. In this case, the calendars for the nurse, the doctor, the x-ray room and the exam room can be scheduled only for the respective periods that they are actually required.

At least some embodiments of the present invention may exhibit one or more of the following objects, advantages and benefits:

(1) allows calendaring and scheduling access rules to be determined on a group by group basis;

(2) allows a group administrator to set and maintain calendaring and scheduling rules for a group of participants;

(3) allows one calendar to be utilized in connection with several different groups (e.g., first employer, second employer, charitable group, sports group, social group);

(4) eliminates or minimizes the need for a person to check multiple calendars computer-based or otherwise) when performing scheduling tasks;

(5) saves time by providing all relevant scheduling and calendaring information in a single calendar;

(6) facilitates integration of intranet, extranet, community and personal scheduling functionality;

(7) use of distinct groups make it easier for an employee of a vendor to integrate a personal calendar along with a calendar used for vendor/customer appointments;

(8) use of distinct groups makes self-reservation by customers practical and less prone to (intentional or unintentional) abuse by customers making self-reservations (including mischievous customers and those unfamiliar with correct use of the calendar);

(9) users can schedule with or be scheduled by colleagues of multiple companies to which they might belong, vendors, customers, community group members, friends and family—all synchronized through a single calendar that checks the availability of people and resources in real time;

(10) new, flexible rules allow new types of computer-based vendor/customer appointment scheduling;

(11) new, flexible rules allow more efficient utilization of vendor personnel and/or vendor resources under a computer-based or self-reservation system;

(12) non-consumable resource scheduling ensures that adequate non-consumable resources, in addition to appropriate personnel, will be available for an appointment; and

(13) consumable resource schedule ensures that adequate consumable resources will be available for an appointment.

According to one aspect of the present invention, a piece of scheduling software for execution by a computer system includes calendar data, group data, sets of access rules and administration software. The calendar data includes machine readable data corresponding to a schedule of events for a schedulee. The group data includes machine readable data corresponding to the identity of groups to which the calendar data and associated schedulee belong. The sets of access rules each respectively include machine readable data and instructions for controlling access to the calendar data by the members of each group. The administration software includes machine readable instructions for allowing each set of access rules to be determined by a separate administrator.

According to a further aspect of the present invention, a piece of scheduling software includes resource calendar data and access rules. The resource calendar data includes machine readable data corresponding to a schedule of events for a resource. The access rules include machine readable data and instructions for controlling access to the calendar data.

According to a further aspect of the present invention, a piece of scheduling software includes calendar data and access rules. The calendar data includes machine readable data corresponding to a schedule of events for a schedulee. The access rules include machine readable data and instructions for controlling revision access to the calendar data so that the schedulee can be simultaneously scheduled for more than one event.

According to a further aspect of the present invention a piece of scheduling software includes sets of calendar data, conflict determination software and access rules. Each set of calendar data includes machine readable data respectively corresponding to a schedule of events for a schedulee. The conflict determination software includes machine readable instructions for determining conflicts between events on the schedules and a proposed event that is proposed to be added to a schedule. The access rules include machine readable data and instructions for controlling revision access to the calendar data so that a reviser can propose and schedule an event with one or more schedulee based on schedulee identity priority information provided by the reviser and conflicts as determined by the conflict determination software.

Further applicability of the present invention will become apparent from a review of the detailed description and accompanying drawings. It should be understood that the description and examples, while indicating preferred embodiments of the present invention, are not intended to limit the scope of the invention, and various changes and modifications within the spirit and scope of the invention will become apparent to those skilled in the art.

### BRIEF DESCRIPTION OF THE DRAWINGS

The present invention will become more fully understood from the detailed description given below, together with the accompanying drawings, which are given by way of illustration only, and are not to be construed as limiting the scope of the present invention. In the drawings:

FIG. 1 is block diagram of a scheduling software computer system according to the present invention.

FIG. 2 is an exemplary screen display generated by the scheduling software of the computer system of FIG. 1 showing a schedulee's view of a schedulee's calendar according to the present invention.

FIG. 3 is an exemplary screen display generated by the scheduling software of the computer system of FIG. 1 showing group information for a calendar.

FIG. 4 is an exemplary screen display generated by the scheduling software of the computer system of FIG. 1 showing a table of exemplary access rules for a group.

FIG. 5 is an exemplary screen display generated by the scheduling software of the computer system of FIG. 1 showing a modification of the level of revision access by a group administrator.

FIG. 6 is an exemplary screen display generated by the scheduling software of the computer system of FIG. 1 showing a view of the schedulee's calendar according to a first level of view access.

FIG. 7 is an exemplary screen display generated by the scheduling software of the computer system of FIG. 1 showing a view of the schedulee's calendar according to a second level of view access.

FIG. 8 is an exemplary screen display generated by the scheduling software of the computer system of FIG. 1 showing a screen for adding an appointment according to a first level of revision access.

FIG. 9 is an exemplary screen display generated by the scheduling software of the computer system of FIG. 1 showing a screen for adding an appointment according to a second level of revision access.

FIG. 10 is an exemplary screen display generated by the scheduling software of the computer system of FIG. 1 showing a screen for adding an appointment according to a third level of revision access.

FIG. 11 is a flowchart for a method of determining availability of a schedulee based on an access rule allowing multiple appoints in a predetermined time period.

FIG. 12 is a flowchart for a method of determining availability of a set of schedulees based in part on schedulee identity priority data.

FIG. 13 is a flowchart for a method of scheduling an appointment requiring a combination of people and resources.

FIG. 14 is an exemplary screen display showing self-reservation of a vendor service by a customer.

FIG. 15 is another exemplary screen display showing self-reservation of a vendor service by a customer.

FIG. 16 is another exemplary screen display showing self-reservation of a vendor service by a customer.

FIG. 17 is another exemplary screen display showing self-reservation of a vendor service by a customer.

FIG. 18 is another exemplary screen display showing self-reservation of a vendor service by a customer.

### DETAILED DESCRIPTION OF THE PREFERRED EMBODIMENTS

Before starting a description of the FIGS., some terms will now be defined.

Definitions

the present invention: means at least some embodiments of the present invention; references to various feature(s) of the “present invention” throughout this document do not mean that all claimed embodiments or methods include the referenced feature(s).

events: any item that can be scheduled on a computer-based schedule; includes but is not limited to service appointments made between vendors and customers.

schedulee: an entity associated with a schedule; the schedulee may be a person, a group of people, an object (such as a dentist's chair), a consumable resource (such as motor oil), a location (such as a conference room), or any other entity that is susceptible to scheduling.

controlling access: means any control or partial control of the way in which view access and/or revision access is implemented; control of access refers not just to identification of parties that are allowed access, but also can relate to the specific manner of access allowed to each party; for example, permission to see which portions of a schedulee's calendar are occupied amount to one level of view access, while permission to see the specific appointments or events on a schedulee's calendar is a different and higher level of view access;

“allowing each set of access rules to be determined by a separate administrator:” does not necessarily mean that the administrator must determine each and every access rule, but rather that the administrators can fashion at least some of the access rules; for example, some access rules may be determined by default settings in the software that can be overridden by an administrator and some access rules may be determined by default settings in the software that cannot be overridden by an administrator.

vendor: one who sells, rents or gives away products and/or services.

customer: one who receives products and/or services from a vendor.

resource: any physical object, location or living thing that can be scheduled for an event; resources include, but are not limited to, things used by vendors during appointments with clients.

consumable resource: a resource that is substantially consumed during a scheduled event.

non-consumable resource: a resource that is not substantially consumed during a scheduled event.

conflict: events on a schedule that are close in time or overlap according to predetermined standards for temporal closeness; depending on the factual context, schedule conflicts may be limited to events that overlap at least partially in time, or conflicts may be more broadly defined to include events that are close in time, but do not overlap.

schedulee identity priority information: any information useful in prioritizing the identity of people, resources or other entities with which a proposed event is to be selectively scheduled; schedulee identity priority information may take the form of a preferred person or resource to be used at a vendor-customer appointment, or may take on any other form that is helpful in distinguishing among multiple entities that are candidates for participation in an event.

To the extent that the definitions provided above are consistent with ordinary, plain and accustomed meanings (as generally evidenced, inter alia, by dictionaries and/or technical lexicons), the above definitions shall be considered supplemental in nature. To the extent that the definitions provided above are inconsistent with ordinary, plain and accustomed meanings (as generally evidenced, inter alia, by dictionaries and/or technical lexicons), the above definitions shall control. If the definitions provided above are broader than the ordinary, plain and accustomed meanings in some aspect, then the above definitions will control at least in relation to their broader aspects.

To the extent that a patentee may act as its own lexicographer under applicable law, it is hereby further directed that all words appearing in the claims section, except for the above defined words, shall take on their ordinary, plain and accustomed meanings (as generally evidenced, inter alia, by dictionaries and/or technical lexicons), and shall not be considered to be specially defined in this specification. Notwithstanding this limitation on the inference of “special definitions,” the specification may be used to evidence the appropriate ordinary, plain and accustomed meanings (as generally evidenced, inter alia, by dictionaries and/or technical lexicons), in the situation where a word or term used in the claims has more than one alternative ordinary, plain and accustomed meaning and the specification is helpful in choosing between the alternatives.

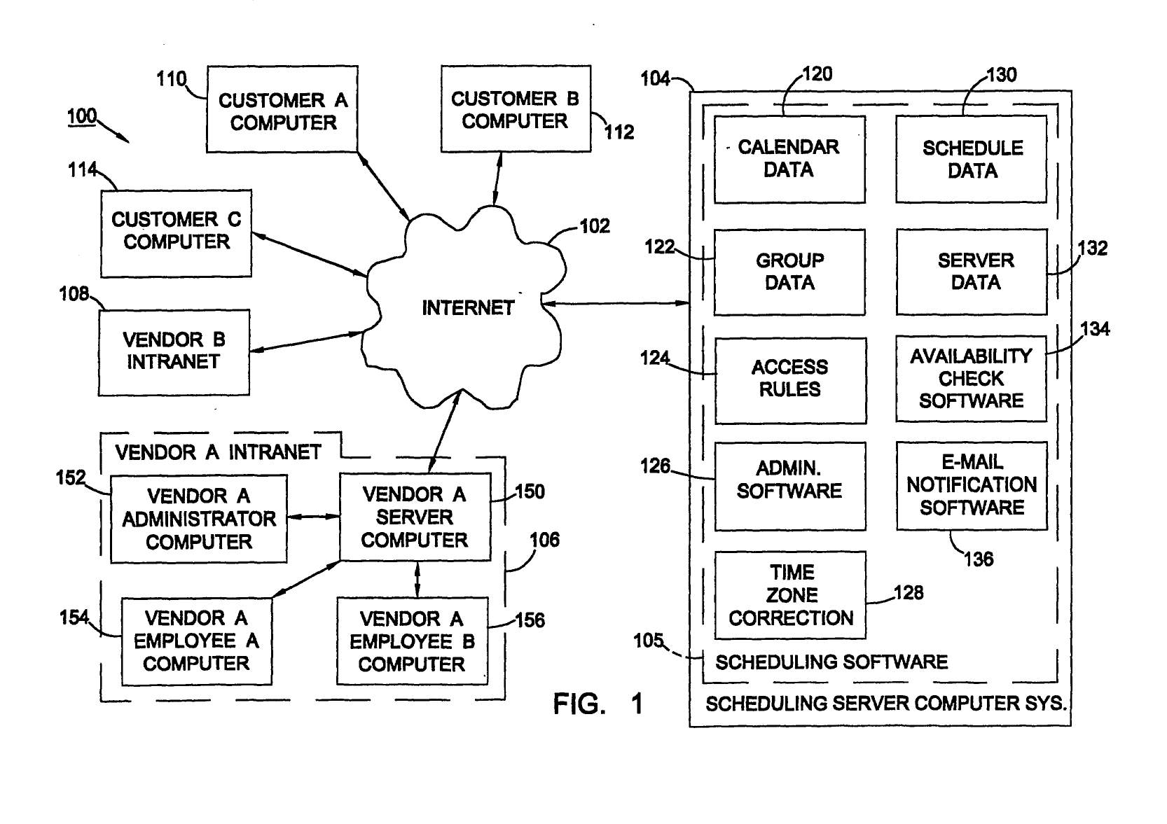

FIG. 1 shows an exemplary scheduling and calendaring computer system 100 according to the present invention. Computer system 100 includes Internet 102, scheduling server computer system 104, vendor A intranet, vendor B intranet 108, customer A computer 110, customer B computer 112 and customer C computer 114. Generally, in this exemplary system architecture, most or all of the scheduling software is stored and maintained among a system of server computers 104 (server computers not separately shown), which is in communication with computers of the various users of the scheduling system over a computer network. However, the scheduling software may be distributed in many different ways among networked computers. Alternatively, there may be no network at all, and the scheduling software may be maintained and used on a single computer (this is a non-preferred embodiment).

Internet 102 is the familiar Internet and associated World Wide Web, and it communicates scheduling data, such as calendars and scheduling requests, between the various computers of the system in conventional ways. Alternatively, Internet 102 could be replaced with any other type of computer network now known or developed in the future (e.g., wireless networks likely to be developed in the future).

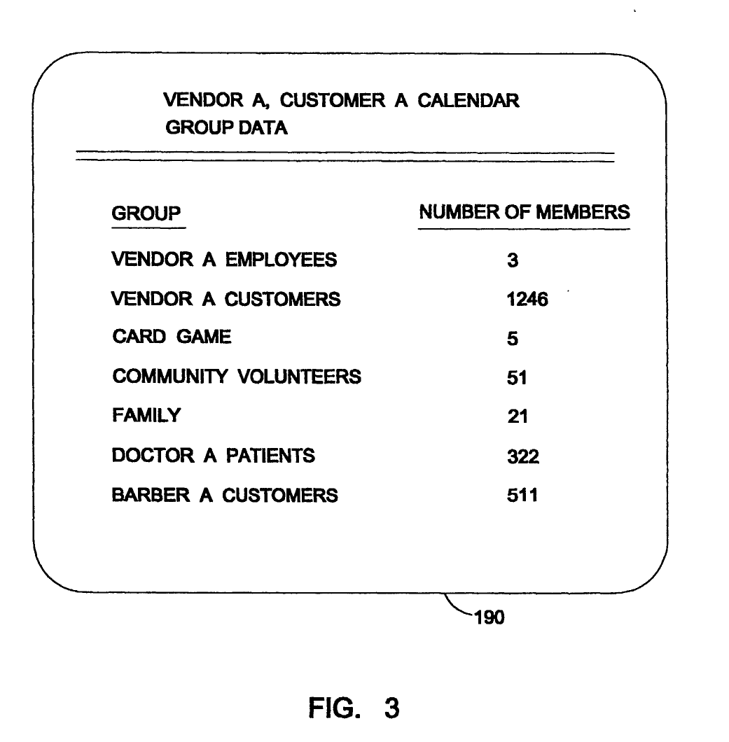

Server computer system 104 is a server computer or set of server computers, capable of acting as a server for a large number of Internet clients. For example, in this embodiment, server computer system 104 serves calendar and scheduling data for thousands of clients (as will be further explained below in connection with FIG. 3). However, as more schedulees and other users of the scheduling software expand into the hundreds of thousands or even millions, server computer system 104 must be equipped with sufficient system resources to handle the increased load.

Server computer system 104 includes scheduling software 105. Scheduling software 105 includes several software modules and databases, including: calendar data 120, group data 122, access rules module 124, administration software module 126, time zone correction module 128, schedulee data 130, service data 132, availability check software module 134 and email notification software module 136. Additional software modules can be added to add features to the scheduling and calendaring functionality that are now known or later developed.

Calendar data 120 is a database for storing calendars for all members of the system. In some embodiments of the present invention, only certain users actually have calendars. For example, if the system is largely made up of vendors and customers, the employees of the vendor may be assigned calendars, while the customers may not generally be assigned calendars. However, in the preferred embodiments, every user of the system gets a calendar. This is advantageous because, assuming that the customers actually take steps to maintain their calendars, the customers' calendars can be automatically checked for availability and schedule conflicts when the customer requests a service appointment from a vendor.

Calendar 120 data preferably has an optimized user interface and collection of computer-based calendar features. For example, the user interface and features of calendar 120 preferably include point and click data and keyboard data entry, display according to different predetermined layouts, ability to print the calendar, reasonable increments of temporal granularity (e.g., 15 minute scheduling units, 1 minute scheduling units), rules for handling conflicting events, email based event addition, event notification and so on. The exact combination of features of calendar data 120 is a matter of design choice.

Group data 122 is an important feature of the present invention, because the concept of having multiple groups associated with a single calendar allows greatly improved administrative control of access to the calendar. In other words, different people in the world at large should preferably have different levels of access to calendar data 120. While it is conventional to give different people different levels of access to a calendar, a problem still remains.

Specifically, somebody must set the access rules for each person with respect to the calendar, assigning trusted people high access on an as-needed basis, while limiting or forbidding access by less important or less trusted parties. If the number of people who have access to the calendar is limited (as it is with intranet based calendars maintained by many employers), then this can be a manageable task. However, if the calendar is to be used by an individual to handle all of his scheduling, then a lot of people will need to access the calendar. Furthermore, the various people who need to access the calendar may not be related to each other. For example, the calendar may preferably make and track events for an individual arising from a first employer, a second employer, a group of friends, family members, community groups, religious groups, school groups and so on.

Assuming that the first employer provided the computer-based calendar to the employee, it is very possible that the first employer will not want to administer access for all of the other users of the individual's calendar. Administration would also be cumbersome if every individual who had a calendar is responsible for administration of view and revision access for their own calendar, because then everybody who has a calendar would have to learn the administration procedures and do the associated administrative tasks. Furthermore, if the individual acts as administrator, the individual may not set appropriate access rules. For example, the individual may (intentionally or unintentionally) block the first employer from having access to the computer-based calendar.

According to the present invention, administration of access is divided into groups. Each group assigns an administrator (or administrators) to administer access to the calendar as appropriate based on the purposes of the groups and the nature of the relationships between people in the group. In this way, there is only one, single unitary calendar for all of the individual's events (this is a big plus), but control over who can see the calendar, and to what degree (if any) others can revise the calendar can be controlled by more than one administrator, with each administrator having the appropriate background knowledge to administer view access and revision access wisely. As a variation, a group may have more than one administrator, but the important point is that most group members can delegate administration of view and revision aspects to a relatively small number of group administrators.

Access rules module 124 is a collection of instructions for implementing various levels of view access to calendars and various levels of revision access to calendars, as will be discussed below. It is the various, alternative access rules of access rules module 124 that group administrators match up with members of their respective groups. Administration software module 126 includes instructions for allowing group administrators to administer access for their respective groups. Time zone correction software 128 performs time zone corrections for users of the scheduling system located in various time zones. For example, if a customer schedules a telephone call to a vendor, time zone correction software 128 can ensure that the schedule call shows up on the vendor's calendar and on the customer's calendar at their respective local times.

Schedulee data 130 is a database that contains required information about various users of the system, such as name, email address, mailing address and so on. As explained below, schedulees are not always people. In the context of vendor service related calendars, calendars may be set up and maintained for non-consumable resources and also for consumable resources.

Service data 132 allows group administrators to define appointments for services. As used herein, an appointment for a service is an appointment that requires the presence of a combination of people, a combination of resources or a combination of people and resources, the group administrator can define exactly what scheduling is necessarily entailed by a service appointment. For example, if the service is an oil change, the service may require one mechanic (a person), one service bay (a non-consumable resource) and three liters of motor oil. By allowing group administrators to define services, customers can self-reserve appointments much more easily, because the customer does not need to know what combination of individuals and resources are required for the type of service that he wants this is taken care of automatically by service data 132 defined by the group administrator for the vendor. Also, while the definition of the service will determine how many and what types of employees and other resources are required for the service, the customer may still be allowed to set priorities or preferences for specific employees and/or resources of the types required to accomplish the service.

Availability check software module 134 checks availability of appropriate calendars with respect to proposed events. Some level of availability checking is conventional. However, according to the present invention, certain new, inventive ways of availability checking can be used. For example, as explained below, availability can be checked for all of the entities (people, resources) required to perform a service as defined by a vendor group administrator in service data 132. Also, as further explained below, availability checking may be prioritized for preferred, alternative entities by an event requestor. For example, a requester for an oil change appointment may request a preferred mechanic and a preferred grade of motor oil for an appointment. Email notification software 136 is conventional software for sending appropriate email notifications for confirmation of appointments, reminders of appointments, rejections of appointments and the like. In this exemplary embodiment, vendor A intranet 106 is a local area computer network set up for employees of an oil and tire change business. Vendor A intranet 106 includes vendor A server computer 150, vendor A administrator computer 152, vendor A employee A computer 154 and vendor A employee B computer. Employees A and B are mechanics of the oil and tire change service, who work from 8 am to 8 pm on Monday through Friday. Vendor A administrator is the manager of the oil and tire change service. Many of the exemplary calendaring scenarios presented below will use employee A's calendar as an example

Vendor B intranet 108 is similar in architecture to vendor A intranet and is, therefore, not shown in detail. Vendor B is another business that needs to calendar service appointments, such a hair salon, a dentist, an optometrist, an insurance agent, a butcher, a baker and so on. Customer A computer 110, customer B computer 112 and customer C computer 114 are computers of various customers of vendor A. Realistically, the number of customers of a business is much larger and may number in the thousands or hundreds of thousands.

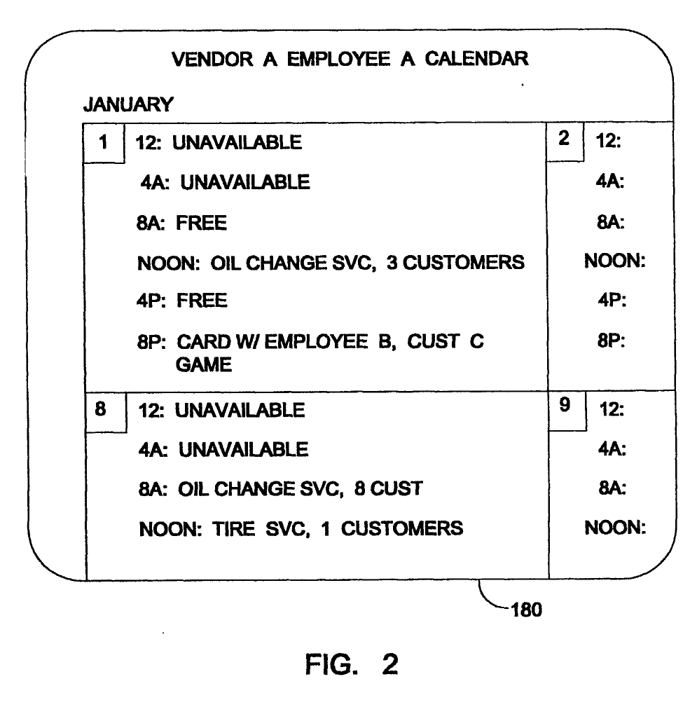

FIG. 2 is a screen display 180 of employee A's calendar as it would appear to employee A (the 4 hour increments are for simplicity of illustration, preferred increments would be smaller). It is noted that details of all appointments are shown, and it makes sense that employee A has full view access of his own calendar and its events. It is also noted that employee A has blocked out midnight to 8 am as unavailable for any appointments every day.

FIG. 3 is a screen display showing the groups to which employee A's calendar belongs. The vendor A employees group has three members, employee A, employee B and the manager of the oil and tire change shop. This group is set up for purposes of scheduling non-customer related work events. Vendor A customers group includes everyone who has or wants to schedule service with the vendor A shop. This is a large group, but the customers will generally have a low level of view access and revision access to employee A's calendar, due to the limited nature of their business relationships with employee A (specifically, he changes their oil and tires).

As shown in FIG. 3, employee A also belongs to a social group called “card game,” a community group called “community volunteers,” a family group, a group of patients of a doctor and a group of clients of a barber. By breaking down administration of access of employee A's calendar into seven groups, it becomes possible to have seven different people formulating access rules, with each administrator controlling view and revision access for a group of users with which they are respectively familiar. Of course, this is likely to lead to much more efficient and effective administration. Whereas employee A may have had to maintain seven different calendars previously, under the present invention, these merge into a single calendar, without the loss of responsible control of access to the calendar.

By belonging to the doctor's patients group and the barber's clients group, employee A may be able to get the benefit of self-reserving appointments over the Internet. By self-reserving appointments, employee A may be able to schedule more quickly and/or with more precision (e.g., barber chair preferences) than he could schedule in the conventional manner over the telephone with a live telephone receptionist. Furthermore, the load on the telephone receptionists for the doctor and the barber may be lightened to the extent that they can be more productive with respect to other office work. Also, the self-reservation functionality may be set up by the doctor and the barber to be available at all times of the day so that employee A can schedule appointments early in the morning or late at night.

Furthermore, when a service appointment requires a combination of employees and/or resources, traditionally the vendor's receptionist had to learn the correspondence between different kinds of appointments, and the employees and the resources that these appointments entailed. As more employees and resources are required, sometimes in a complex pattern of overlapping time intervals, the memory and analytical abilities of the receptionist may be taxed and may even make an error in adjusting schedules for the various employees and resources required for the appointment. On the other hand, according to the present invention, the definition of services are programmed by an administrator and the sometimes-complex rules that govern appointments are basically written into the software by the group administrator. In this way, only the computer must remember the rules, and the scheduling is less subject to error.

It is noted that FIG. 3 shows the number of members of each group. First, this is not necessary, but is shown in this example to give an idea that groups may vary widely in size and purpose. Second, the number of group members given for vendor A doctor A or barber A may not fully reflect the respective numbers of customers that these service providers have. For example, these businesses may have many customers who do not have access to computers, who do not join the calendar group and who have to make all appointments the old-fashioned way through a live receptionist. The receptionist makes appointments on behalf of customers, using the same software, the same user interface screens and the same alternatives as the customer would have if the customer self-reserved the appointment over the Internet. The receptionist will generally be prompted to add these customers as group members so that the receptionist or the customer can more readily make reservations on future occasions through the scheduling software.

As a further alternative, a user may have access to further information about other group members, such as email addresses. In this way, group members can contact each other. Additionally, groups may have associated message boards, chat rooms and the like. For example, if the group is a group of parents of school age children, the calendar group may allow effective electronic communication among group members.

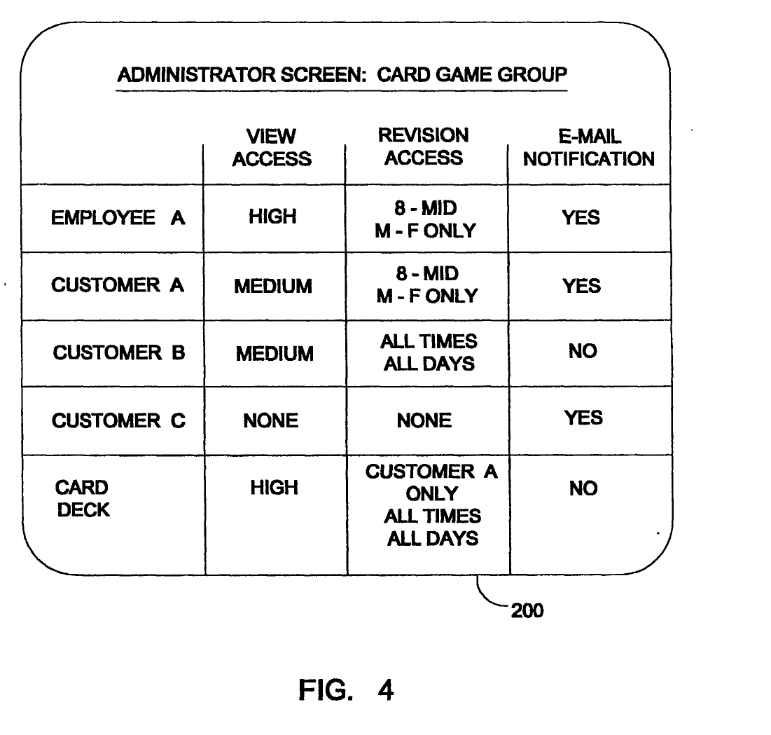

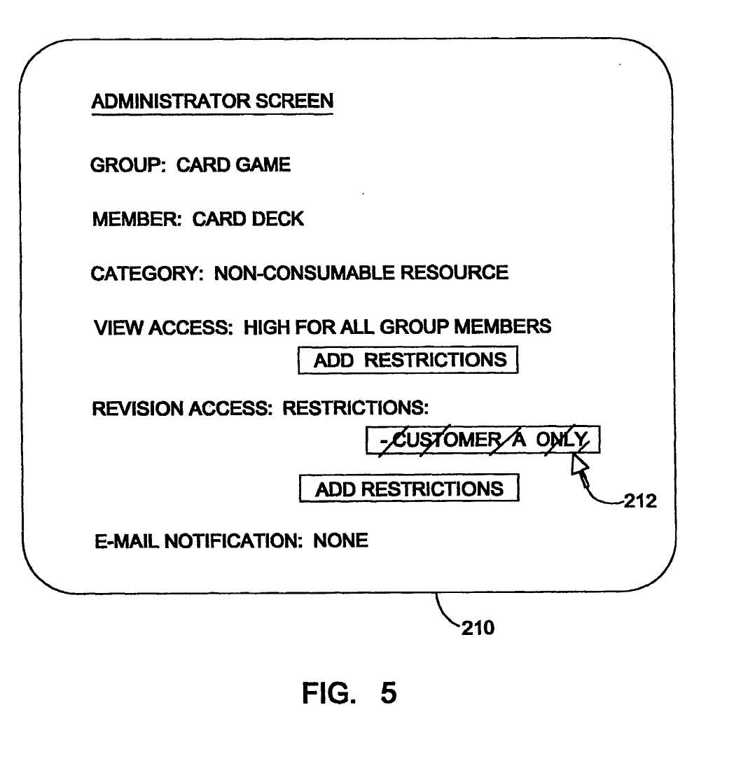

FIG. 4 shows screen display 200, which is an administrator screen for the card game group to which employee A belongs (see FIG. 3). Employee A happens to be the administrator for this group, so he has access to the administrator screens of FIG. 4 and FIG. 5. In screen display 200, the five members of the card game group are shown in tabular form along with their associated levels of access, access restrictions and email notification protocols. The group includes 4 people (three of whom happen to also be customers of the vendor A oil and tire change shop).

For example, the group is allowed a medium level of view access to customer A's calendar. This may mean that the group members can view available and unavailable time slots, without being allowed to see what the scheduled events actually are and who is participating. In this way, customer A is allowed some privacy, while the group still gets the information it needs to schedule games of poker and other card games. The group is allowed to revise customer A's calendar, but is restricted to making its revisions for weekday evenings only. This restriction helps prevent group members from scheduling card games while customer A is at work, or during other undesirable times. Finally, because customer A's email notification feature is turned on, customer A will receive notification whenever customer A has an appointment.

Because customer A owns the card deck (non-consumable resource) used by the group, customer A has requested that only he be allowed to schedule the card deck. More particularly, the card deck is given a calendar, just like a person. While control of the card deck may seem unnecessary in the context of a small group of card players, vendors who have many and/or resources may need to carefully allot these resources as carefully and deliberately as his employees.

FIG. 4 does not show all the possible view access restrictions, revision access restrictions, user interface alternatives, email notification alternatives and the like over which a group administrator may be given control. Rather, FIG. 4 merely attempts to illustrate the concept that a group administrator has control over view access, revision access and other features of the calendaring process implemented by the scheduling software. The more granulated the control given to the group administrator (that is, the more alternatives and features that the group administrator is allowed to control), the more cumbersome his administrative work becomes. On the other hand, more refined control can help the group administrator tailor each group members user interface and access to better suit the needs of specific individuals. The level of control given to the group administrator will vary widely between embodiments (and perhaps within embodiments) of the present invention.

FIG. 5 shows another administrator screen 210 that employee A uses in his role as administrator of the card game group. In this case, employee A is changing the access rules applicable to the calendar for the card deck. Specifically, employee A is manipulating cursor 212 to change revision access for the calendar of the card deck. For example, he may change revision access to specify that employee A himself can set appointments on the card deck calendar in addition to customer A (the owner of the deck). Similarly, businesses, such as vendor A can control revision access among their customer groups to allow self-reservation by trusted customers and to end revisions access for customers that have proven themselves incapable of responsibly using the self-reservation feature.

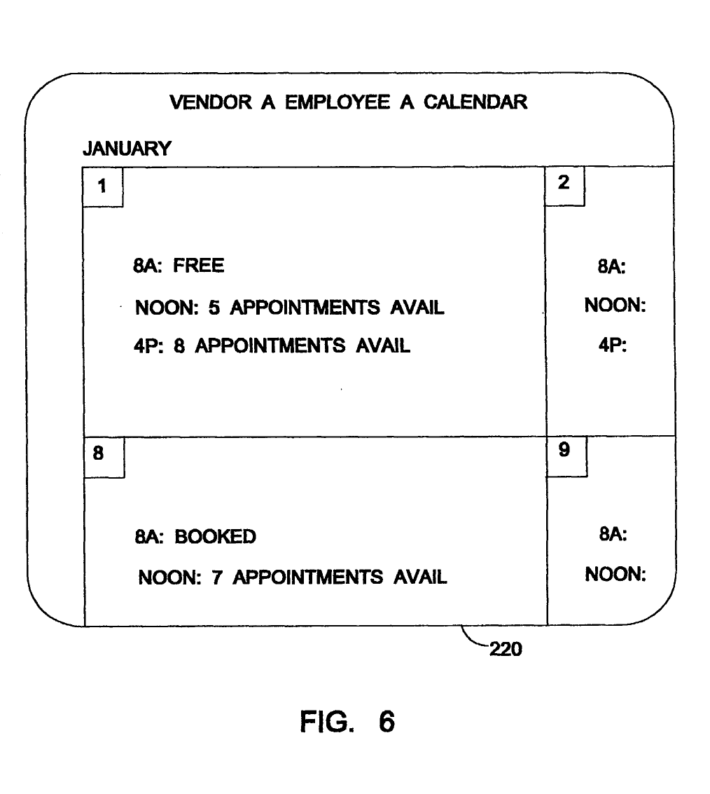

FIG. 6 shows screen display 220, which is a view of employee A's calendar granted to a vendor A customer. The customer can only see the portion of the calendar corresponding to employee A's working hours, and even during these hours the customer can only see whether employee A is available for further appointments, or whether employee A is booked. This limited view access respects employee A's privacy, while allowing the customer a reasonable amount of information to use in deciding when to request an oil change or tire change appointment.

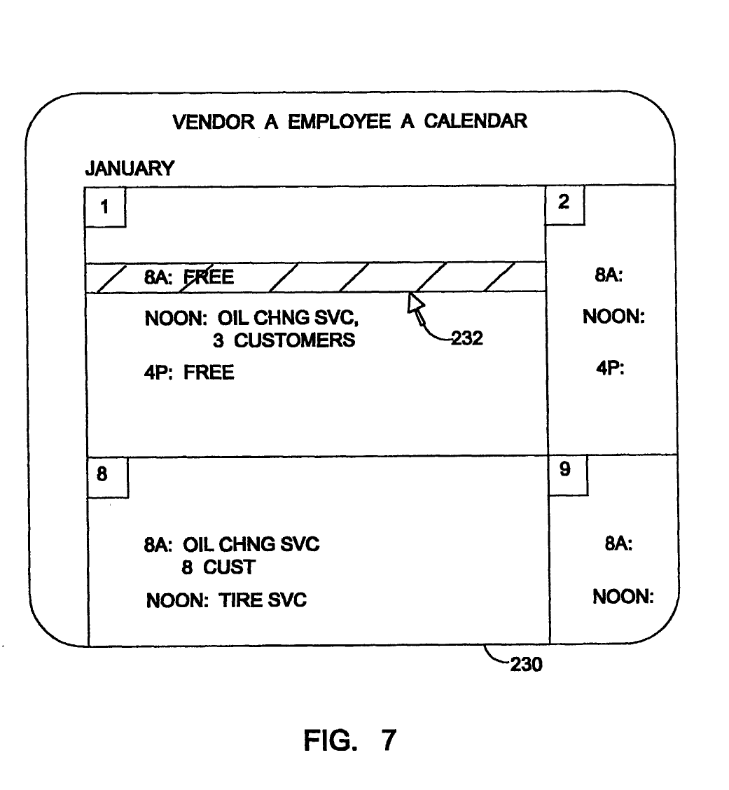

FIG. 7 shows screen display 230, which corresponds to yet another level of view access for employee A's calendar. Specifically, this is the level of view access that the oil and tire change shop has granted himself to employee A's calendar as a member of the vendor A employees group (see FIG. 3). As shown in FIG. 7, the manager can see employee A's schedule in detail during working hours, but cannot see any of employee A's schedule during non-working hours. As shown in FIG. 7, the manager is using cursor 232 to schedule a work related meeting on the morning of January 1 (when employee A is fortunately available).

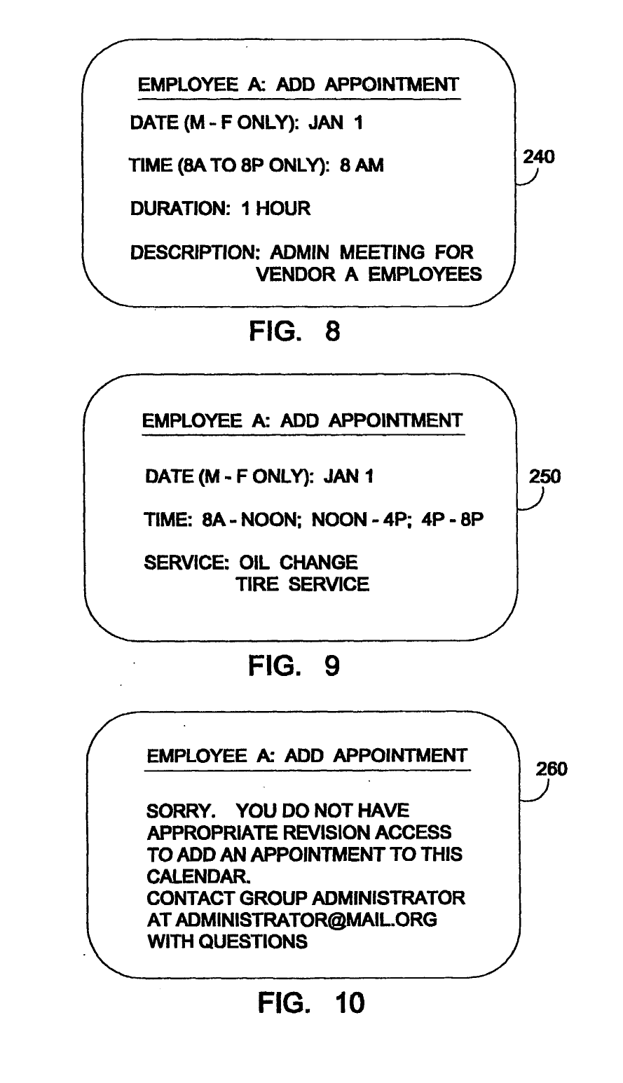

FIGS. 8 to 10 demonstrate how a calendar can be subject to different levels of revision access. In FIG. 8, screen display 240 shows a screen used by the manager of vendor A to add an appointment. As discussed above, the manager belongs to the vendor A employees group (see FIG. 3), which is one of the groups associated with employee A's calendar. Being the administrator of the vendor A employees group, the manager has previously set his level of revision access (see above discussion of FIG. 7), and has allowed himself free reign to make appointments on this calendar during working hours. This is why screen display 240, presented to the manager in making the appointment, limits date to Monday through Friday, and limits times from 8 am to 8 pm. The manager's level of revision access is well-tailored to the employment relationship that he has with employee A.

FIG. 9 shows screen display 250, which is an appointment-setting screen presented to a member of the vendor A customers group. The customer is limited to Monday through Friday (the days that the oil and tire change shop is open), and is also limited to predefined 4 hour time slots. This is because the oil and tire services offered by the shop each take 4 hours. Also, the customer cannot define any sort of appointment, rather, the customer can request oil change service or tire change service, but has no other alternatives. By comparing FIG. 8 with FIG. 9, one can get an idea of the many ways that the level of revision access can be changed. More particularly, users can be given more or less freedom with respect to the type of appointments they make, the days of the week, the time of day, the duration, identity of parties who can revise and so on.

Also, there are different ways of confirming new appointments or events. FIGS. 8 and 9, show self-reservation situations, wherein the appointment requires no confirmation, but rather is unilaterally made (within prescribed limits) by the requestor. However, sometimes it is more appropriate to have the requestor merely request an appointment (e.g., by email), which then must be confirmed by the schedule. The existence and mode of required event confirmation are other aspects of revision access that can be controlled according to the present invention.

Still another type of limitation on revision access is the requirement of permission to even make a request of a schedules to schedule an appointment. In this case, the requestor must not only request, rather than mandate, a scheduling event, but must additionally get permission to make a request. For example, a large company may schedule a large picnic for the employees. It is desired to invite all employees to the picnic, through appropriate email requests to schedule the event on the employee's respective calendars. However, the power to send out a request to so many employees is a power that must be used responsibly. Therefore, permission may be required to even make this request (even though the request does not, in itself, obligate anybody to anything).

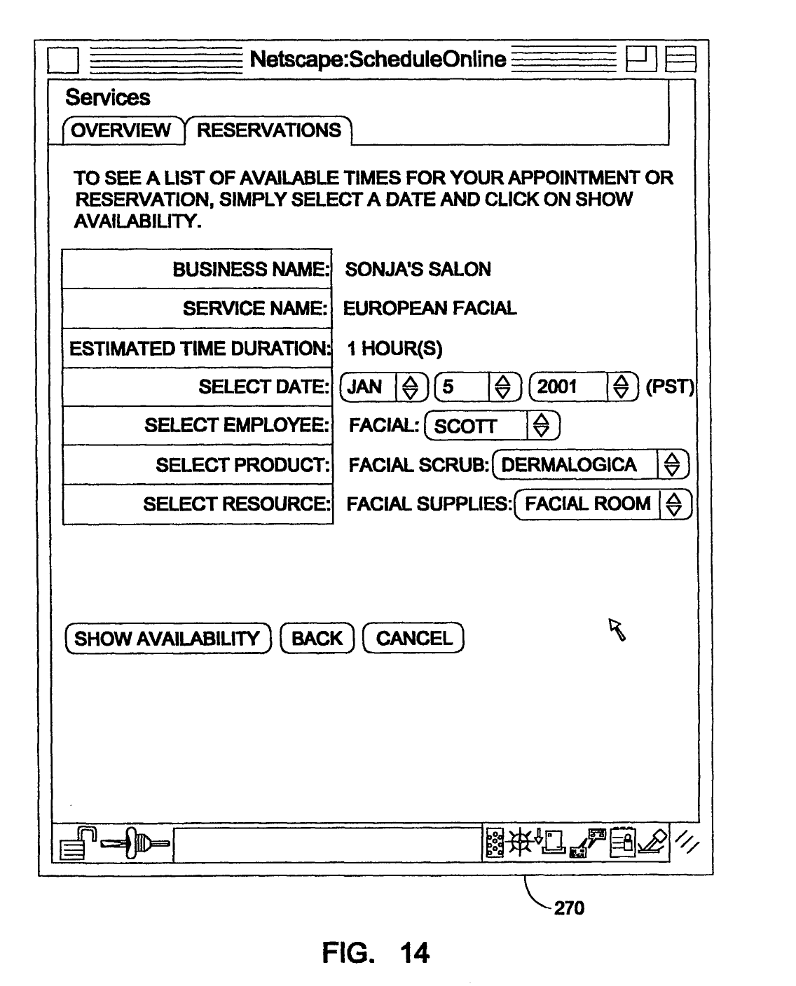

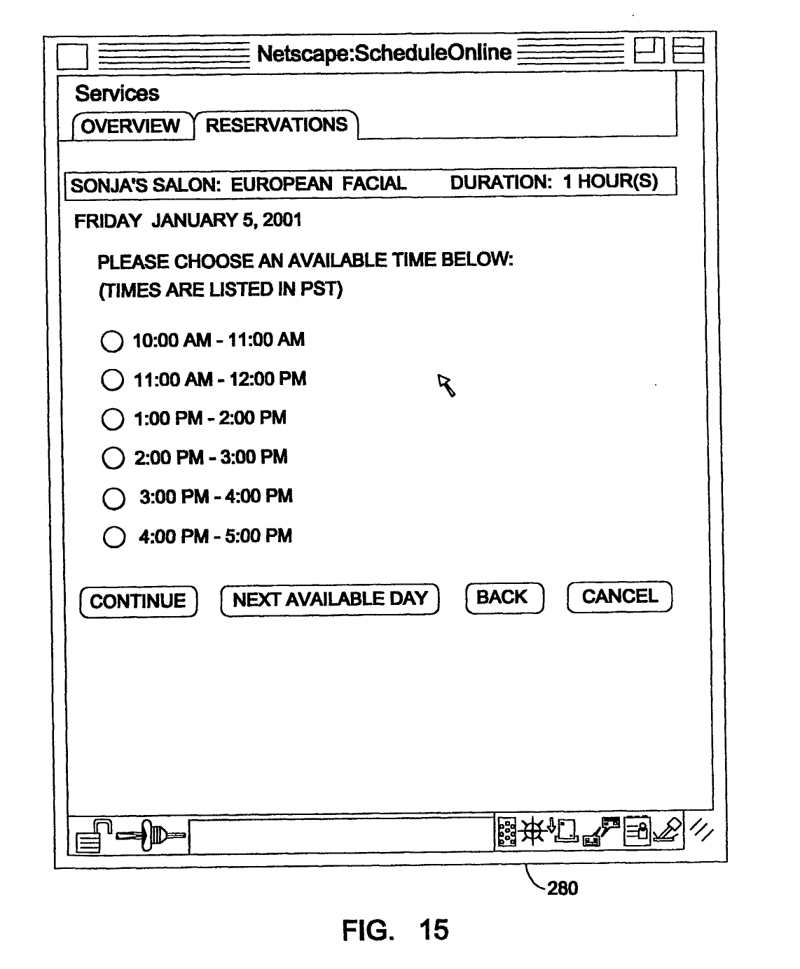

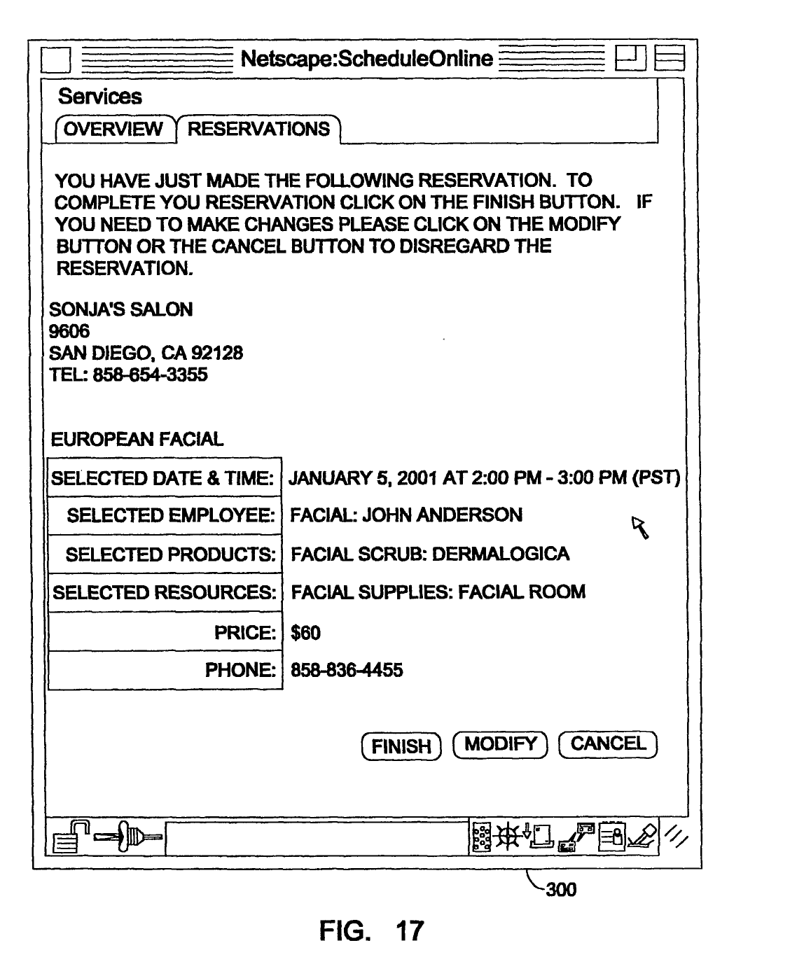

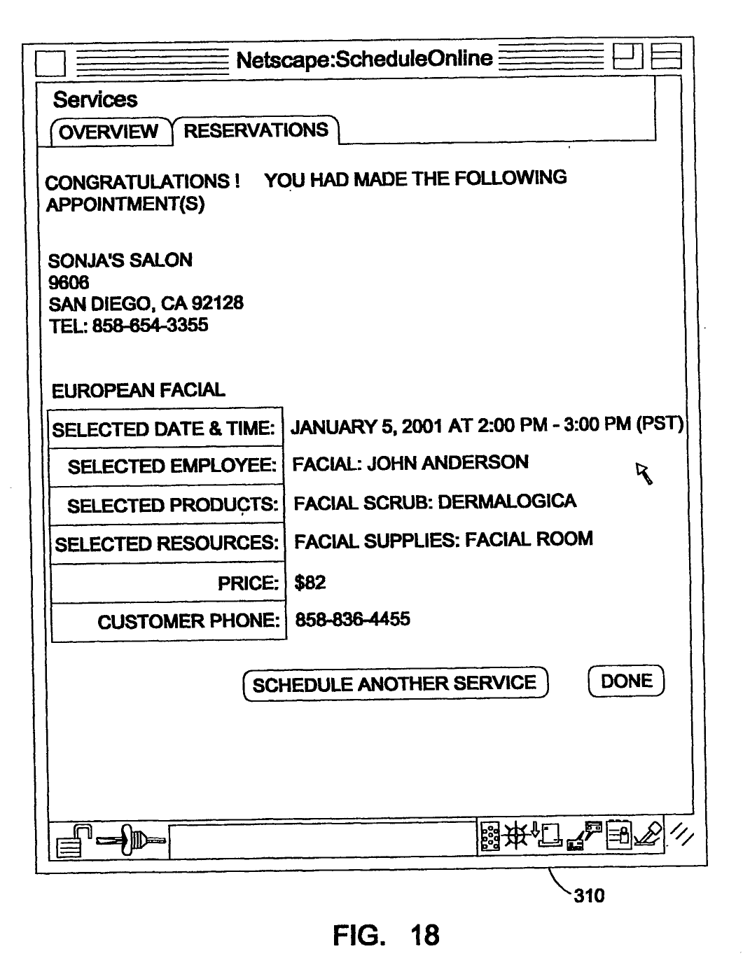

While FIG. 9 shows a very simple service appointment setting screen for purposes of illustration, it is noted that service businesses (such as an oil change shop or a doctor's office) should try to present their customers with choices in a user friendly way. When there are a lot of services, a lot of variations on the services, a lot of different people providing the services and so on, the self-reservation may entail a lot of separate screens and associated on-screen boxes to check or to type text into. FIGS. 14 to 18 respectively show screen displays 270, 280, 290, 300, 310, which are exemplary user-friendly screen displays utilized when a customer self-reserves an appointment.

FIG. 10 shows screen display 260, which is a screen display generated when someone from the barber A customers group (see FIG. 3) attempts to automatically set up an appointment with employee A. While members of the barber A customers group should probably be able to self-reserve appointments with a barber, there is no reason to allow them to set up appointments with each other, and furthermore, if they are allowed to set up appointments with each other, this privilege may be abused (accidentally or intentionally). Therefore, the administrator of the barber A customers group has set revision access to employee A's calendar (as well as the calendars of barber A's other customers) to forbid any appointments from being automatically set to the customers calendars through the barber A customer's group.

FIGS. 8 to 10 demonstrate that various levels of revision access are important in maintaining one calendar to use with respect to the many and various types of parties out in the world, but the more subtle advantage is that different administrators set the different levels of revision access. It is not very efficient to have a single administrator be responsible for everybody's level of revision access. By breaking administration of revision and view access into groups, each group administrator has a manageable portion of the burden (as well as the incentive and knowledge to do the job correctly).

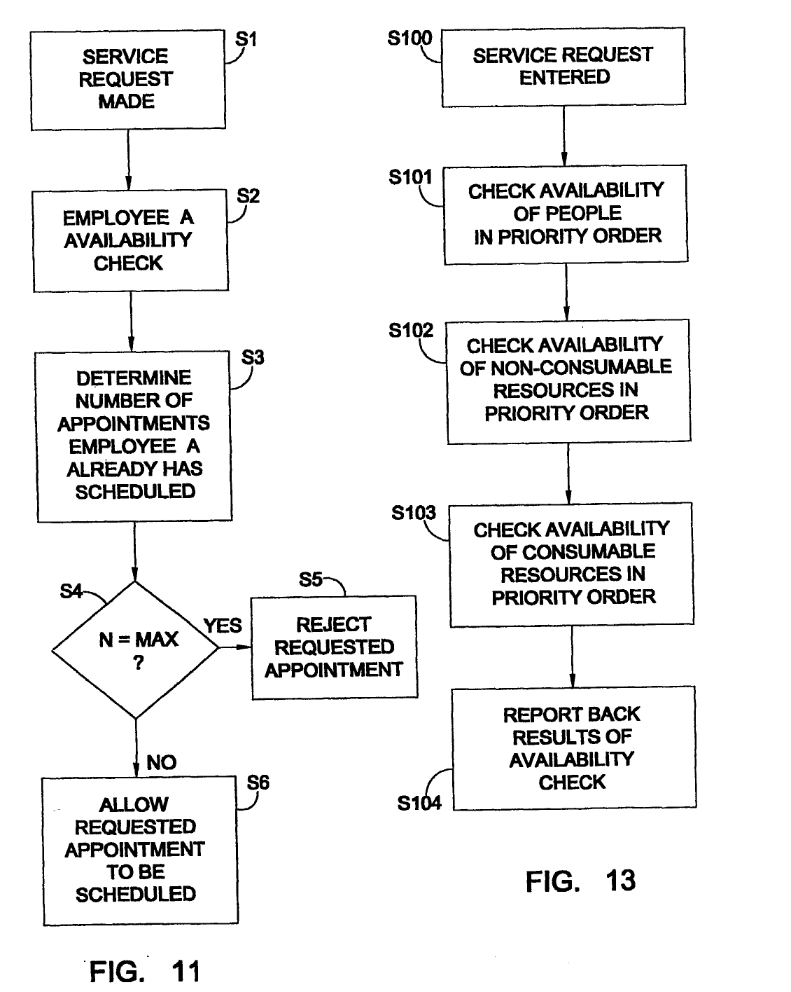

FIG. 11 is a flow chart showing the feature of the present invention wherein more than one appointment can be made over a predetermined time interval, and also the feature of limiting the number of appointments that can be made in the time interval. Conventionally, scheduling software either allows unlimited “conflicts” (that is, overlapping or near-overlapping events) or it does not allow conflicts at all. This is not always realistic. For example, a doctor may want to schedule 5 patients for every hour long interval (without specifying the order in which he will see the patients). As a further example, the tire and ol change shop may want to schedule a maximum of 8 appointments for every four hour interval (see FIG. 6 at January 1, 4 pm to 8 pm).

The scheduling software can accommodate this by the method of FIG. 11. At step S1 of the FIG. 11 flowchart, a customer makes a request for a service. At step S2, the availability of a required or desired person or resource (employee A in this example) is checked. At step S3, the number of service appointments N that employee A already has on his schedule for the requested time interval is checked. At step S4, it is determined whether N is already equal to the predetermined maximum number of appointments (this predetermined maximum can be set by the administrator based on the way that the business normally runs).

If N is determined to be equal to the predetermined maximum at step S4, then processing proceeds to step S5, wherein the requested appointment is rejected. On the other hand, if N is determined to be less than the predetermined maximum at step S4, then processing proceeds to step S5, wherein the requested appointment is scheduled.

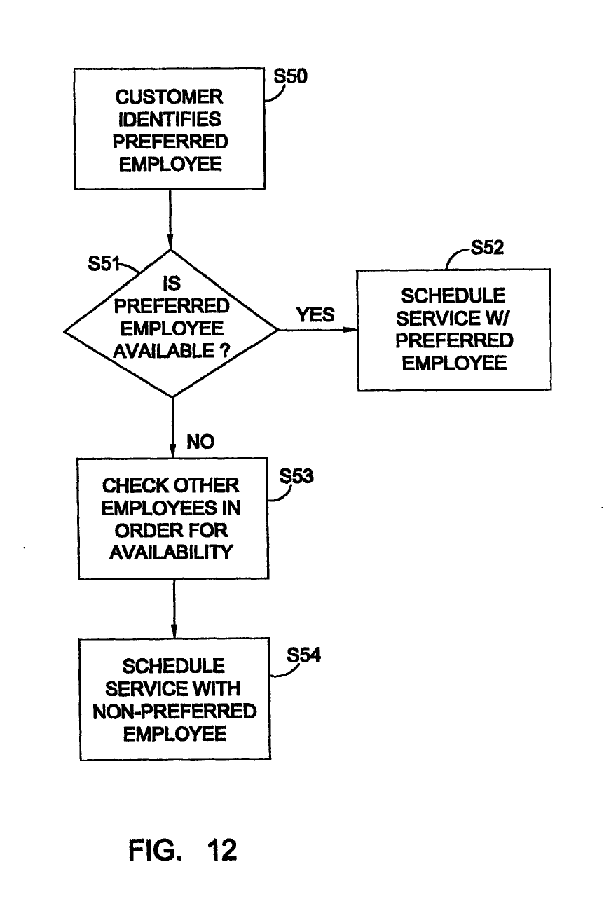

FIG. 12 shows a flow chart that shows how customers may indicated preferences for certain people or resources when self-reserving an appointment. For example, as shown in screen display 270 of FIG. 14, a certain employee and brand of facial scrub have been chosen as preferred for an appointment for a facial. At step S50 of FIG. 12, the customer identifies a preferred employee. At step S51, it is determined whether the preferred employee is available.

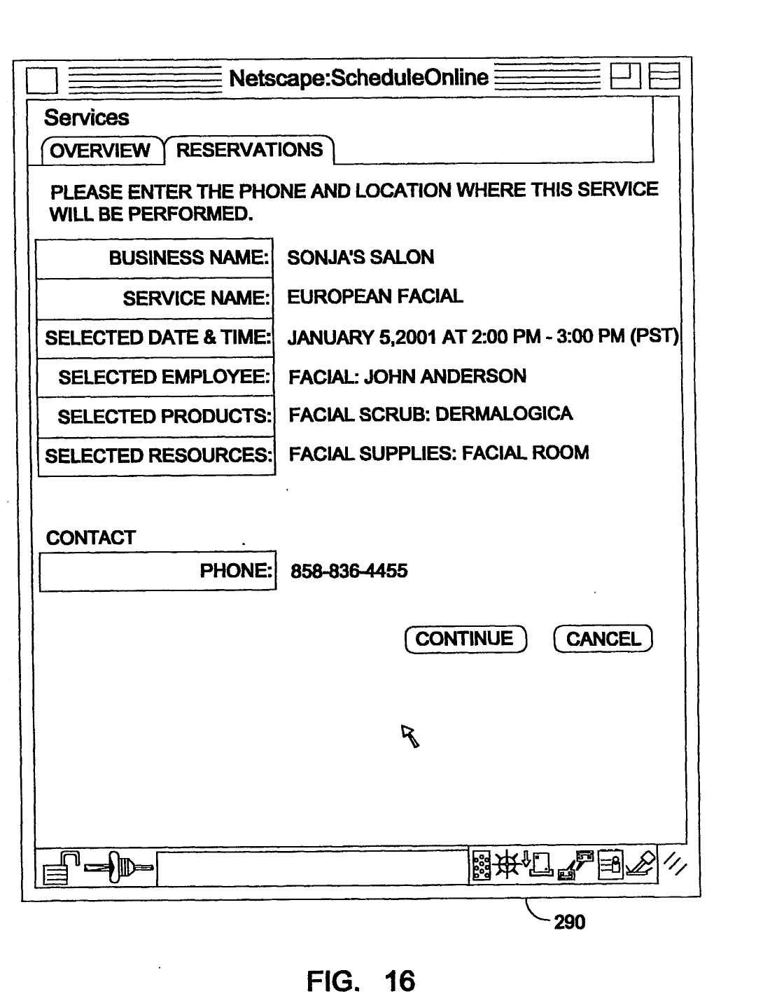

If the employee is available, processing proceeds to step S52, wherein the appointment is made with the preferred employee. On the other hand, if the preferred employee is not available, then processing proceeds to step S53, wherein other qualified employees are checked for availability (in a variation on the processing of the flow chart of FIG. 12, the requestor could set a priority order for some or all of the qualified employees). At step S54, the service is scheduled with a non-preferred employee. For example, as shown in FIGS. 16 to 18, the employee requested in FIG. 14 was not available, and an alternative employee was alternatively selected.

FIG. 13 shows the feature of the present invention wherein a request for service can be used to automatically schedule a combination of people and resources using a single unitary request. At step S100, the service request is entered by the requestor. At step S101, the availability of the employees qualified to perform the service. The administrator who defines the service determines how many people are required for the service and which employees are qualified to do each role. For example, a medical exam may require a doctor and a nurse. (The doctor's office may have more than one doctor and/or more than one nurse—in this case, availability for all the doctors and all the nurses may be determined.)

At step S102, the availability of non-consumable resources (e.g. an examination room in a doctor's office) is checked. At step S103, the availability of consumable resources (e.g., tongue depressors) is checked. At step S104, the availability of the combination of people and resources is reported back. If the right people and the right resources are available, then the appointment can be made. On the other hand, if a required person or resource is not available, it may be better to schedule the appointment at a different time.

Many variations on the above-described scheduling software are possible. Such variations are not to be regarded as a departure from the spirit and scope of the invention, but rather as subject matter intended to be encompassed within the scope of the following claims, to the fullest extent allowed by applicable law.

What is claimed is:

1. A machine (100) structured to execute machine readable instructions in the form of software, the software comprising:
calendar data (120) comprising machine readable data corresponding to a schedule of events for a schedulee;
group data (122) comprising machine readable data corresponding to the identity of groups to which the calendar data and associated schedulee belong; and
a plurality of sets of access rules (124), each set of access rules respectively comprising machine readable data and instructions for controlling access to the calendar data by the members of each group; and
administration software (126) comprising machine readable instructions for allowing each set of access rules to be determined by a separate administrator.

2. The machine of claim 1 further comprising calendar display software comprising machine readable instructions for displaying the schedule in the form of a calendar.

3. The machine of claim 1 wherein the schedulee is a person.

4. The machine of claim 1 wherein the schedulee is a resource.

5. The machine of claim 1 wherein the group data comprises machine readable data corresponding to the identity of each member of each group.

6. The machine of claim 1 wherein the groups comprise at least one group defined by employment relationships.

7. The machine of claim 1 wherein the groups comprise at least one group defined by participation in a vendor-customer relationship.

8. The machine of claim 1 wherein the groups comprise at least one group defined by participation in a social relationship.

9. The machine of claim 1 wherein the access rules comprise machine readable data and instructions for controlling a level of view access to the schedule.

10. The machine of claim 1 wherein the access rules comprise machine readable data and instructions for controlling a level of revision access to the schedule.

11. The machine of claim 1 wherein each set of access rules controls access for each group member based on the identity of each group member.

12. The machine of claim 1 wherein at least one set of access rules allows at least some members of a group to add events to the schedule without any action on the part of the schedulee.

13. A machine (100) structured to execute machine readable instructions in the form of software comprising:
resource calendar data (130) comprising machine readable data corresponding to a schedule of events for a resource (210); and
access rules (124) comprising machine readable data and instructions for controlling access to the calendar data.

14. The machine of claim 13 wherein the resource is a non-consumable resource.

15. The machine of claim 14 wherein the resource is a piece of hardware used by a vendor in conjunction with providing a service to a client.

16. The machine of claim 13 wherein the resource is a consumable resource.

17. The machine of claim 13 further comprising:
a plurality of sets of personal calendar data, with each set of personal calendar data comprising machine readable data respectively corresponding to a schedule of events for a person; and
wherein the access rules further comprise availability checking rules comprising machine readable instructions for checking availability of the resource calendar data and at least one set of personal calendar data simultaneously.

18. A machine (100) structured to execute machine readable instructions in the form of software comprising:
calendar data (120) comprising machine readable data corresponding to a schedule of events for a schedulee; and
access rules (124) comprising machine readable data and instructions for controlling revision access to the calendar data so that the schedulee can be simultaneously scheduled for more than one event.

19. The machine of claim 18 wherein access rules further comprise machine readable instructions for controlling revision access so that the schedulee can be scheduled for a predetermined maximum number of events over a predetermined time period.

20. A machine (100) structured to execute machine readable instructions in the form of software comprising:
a plurality of sets of calendar data (120), with each set of calendar data comprising machine readable data respectively corresponding to a schedule of events for a schedulee;
conflict determination software (134) comprising machine readable instructions for determining conflicts between events on the schedules and a proposed event that is proposed to be added to a schedule; and
access rules (124) comprising machine readable data and instructions for controlling revision access to the calendar data so that a reviser can propose and schedule an event with one or more schedulee based on schedulee identity priority information provided by the reviser and conflicts as determined by the conflict determination software.
